(19) United States
(12) Patent Application Publication
(10) Pub. No.: US 2016/0166117 A1
(43) Pub. Date: Jun. 16, 2016

(54) Cooking Utensil Caddy

(71) Applicant: Charles Adewale Oduguwa, Tega Cay, SC (US)

(72) Inventor: Charles Adewale Oduguwa, Tega Cay, SC (US)

(21) Appl. No.: 14/283,223

(22) Filed: May 21, 2014

(51) Int. Cl. A47J 47/16; A47G 21/14

(52) U.S. Cl. CPC A47J 47/16; A47G 21/14

(57) ABSTRACT

A cooking utensil caddy for storing a plurality of cooking utensils sideways during and after cooking in an organized fashion, comprising a rigid container having a plurality of curved compartments for holding and storing cooking utensils. Each of the curved compartment having a lowered front wall with a u-shaped cutout for holding the cooking utensils in place.

### BACKGROUND OF INVENTION

This invention pertains generally to the field of household organization more specifically, this invention relates to a functional rest for multiple cooking and/or serving utensils including but not limited to; spoon, fork, knife, pot lid, spatula, or other similar items all further referred to as utensil, kitchen utensil, or cooking utensil in this document.

Despite significant improvements in several areas of kitchen organization, utensil rest or spoon rest as commonly known technology has seen very little practical improvement. The market currently offers plates and bowls of various shapes and sizes that simultaneously function as cups, bowls and utensil or spoon rest, none addressing the problem of comingling in combination with space saving. This invention pays particular attention to the need to organize a number of cooking utensils during and after cooking and or serving. This invention is therefore a dedicated cooking utensil caddy.

### BRIEF SUMMARY OF INVENTION

This is an operational cooking utensil caddy for one or more cooking utensils, such that the cooking utensil caddy is equipped with curved compartments for effectively holding and compartmentalizing curved and straight cooking utensils rested on their sides or spines for compactness, and to facilitate draining that reduces dripping with a U shaped cutout on the front wall of each compartment for resting the neck of each utensil in place.

One object of the invention is to create a cooking utensil caddy for one or more cooking utensils such that the utensil resting compartments are curved to effectively accommodate curved and straight cooking utensils.

Another object of the invention is to create a cooking utensil caddy for one or more cooking utensils such that fluid draining from each cooking utensil is contained within the individual respective resting compartment.

A further object of the invention is that the cooking utensils are completely separated from each other as they are rested in separate compartments of the cooking utensil caddy.

A further object of the invention is that the neck of the utensil in each compartment is rested in a U shaped cutout on the front wall of each compartment of the cooking utensil caddy.

A further object of the invention is the space saving method of resting the utensils on their sides for compactness and reduced exposure.

A further object of the invention is its design for effective storage shelf stacking.

BRIEF DESCRIPTION OF THE SEVERAL VIEWS OF THE DRAWING

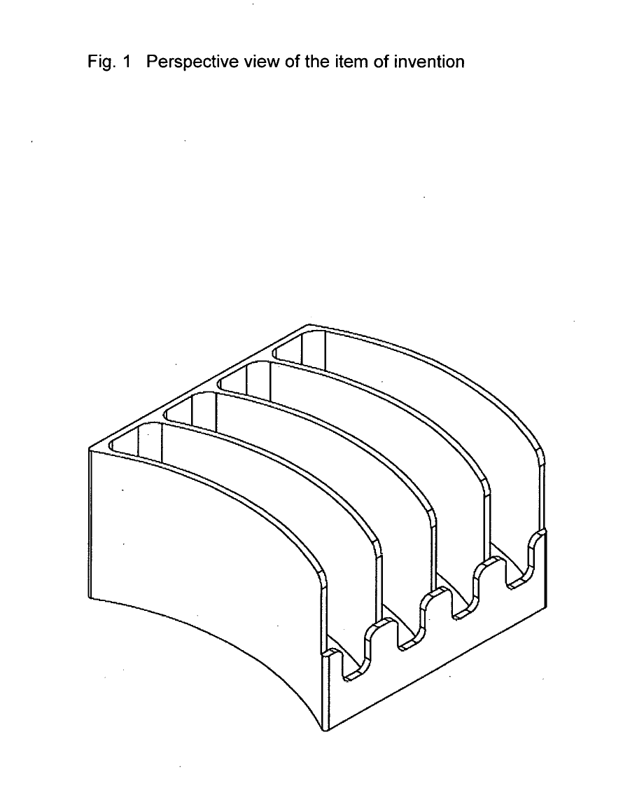

FIG. 1

Perspective view of the item of invention

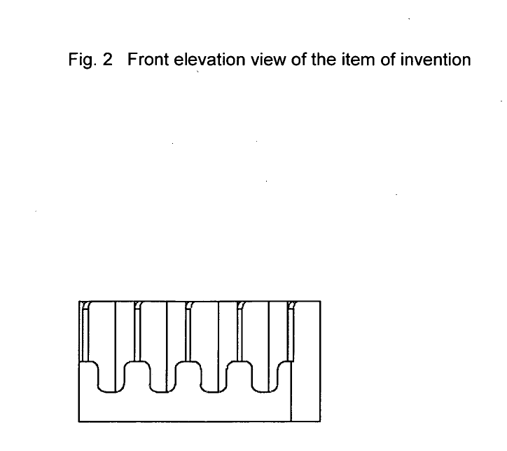

FIG. 2

Front elevation view of the item of invention

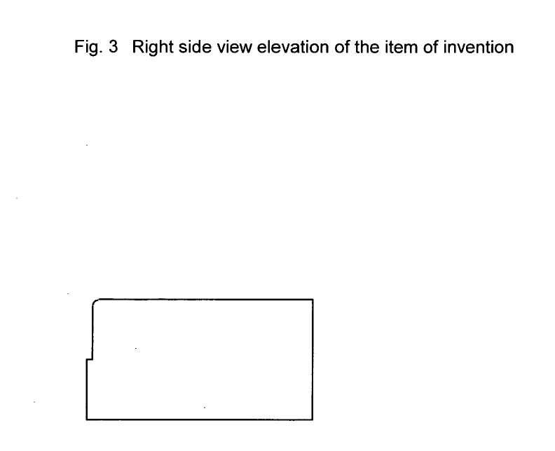

FIG. 3

Right side plan view of the item of invention

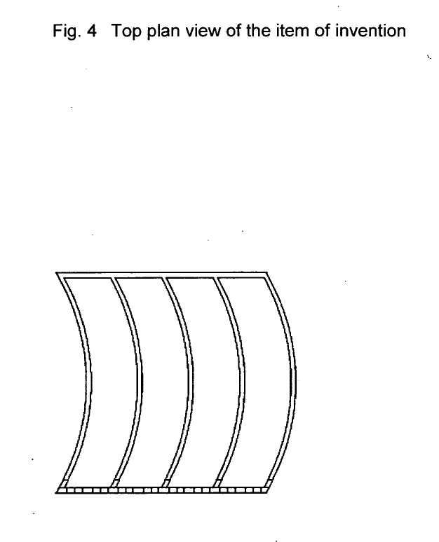

FIG. 4

Top plan view of the item of invention

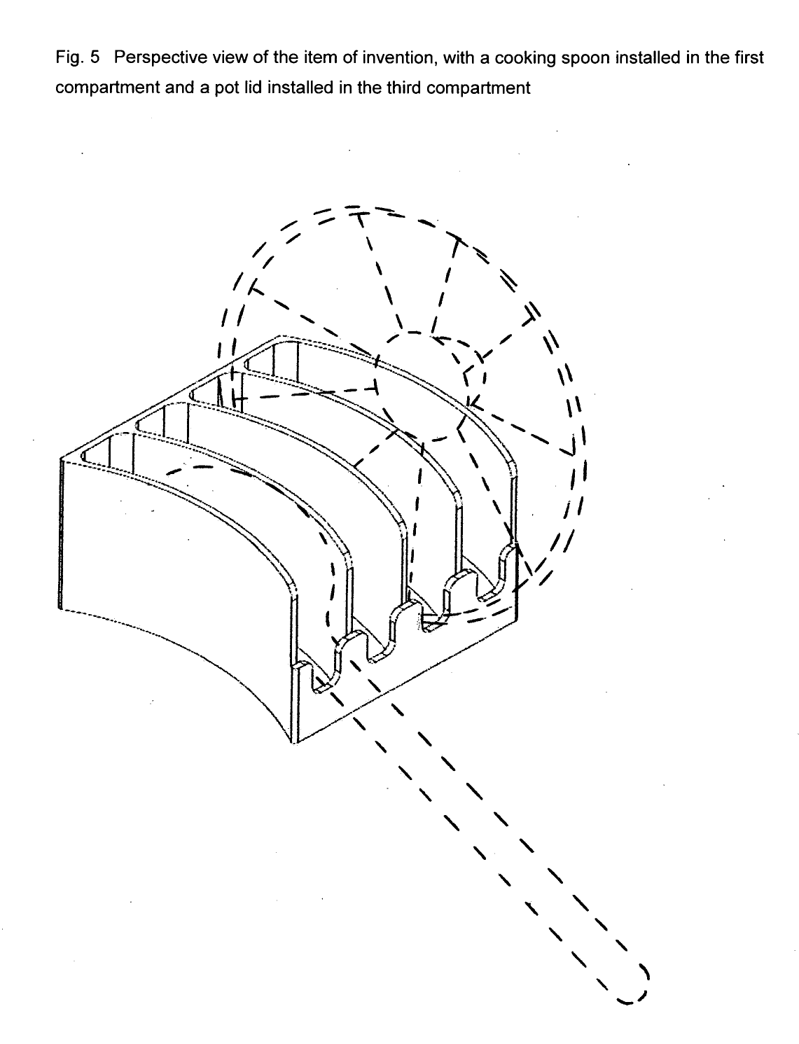

FIG. 5

Perspective view of the item of invention, with a cooking spoon installed in the first compartment and a pot lid installed in the third compartment

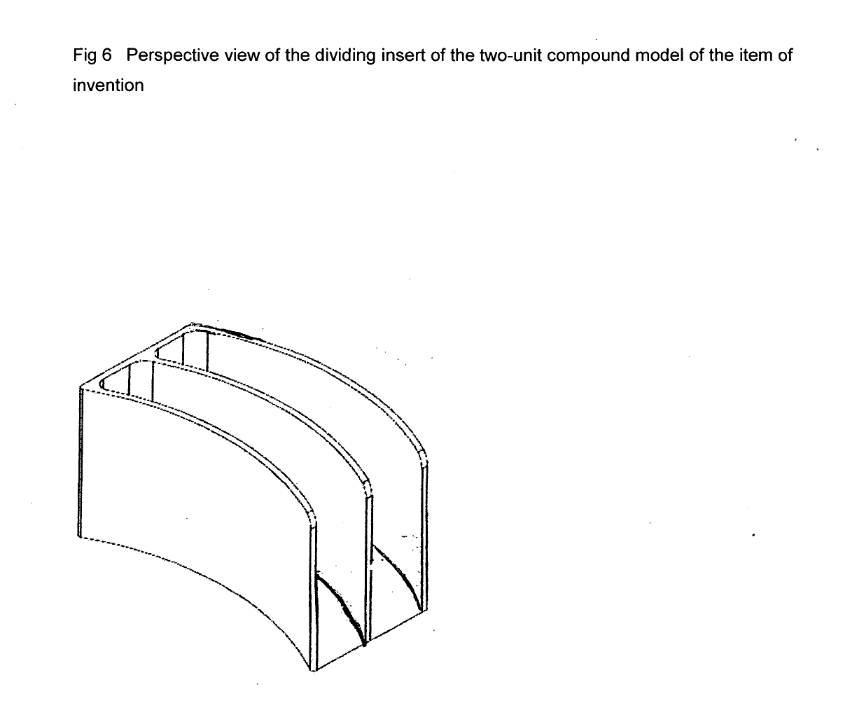

FIG. 6

Perspective view of the dividing insert of the two-unit compound model of the item of invention

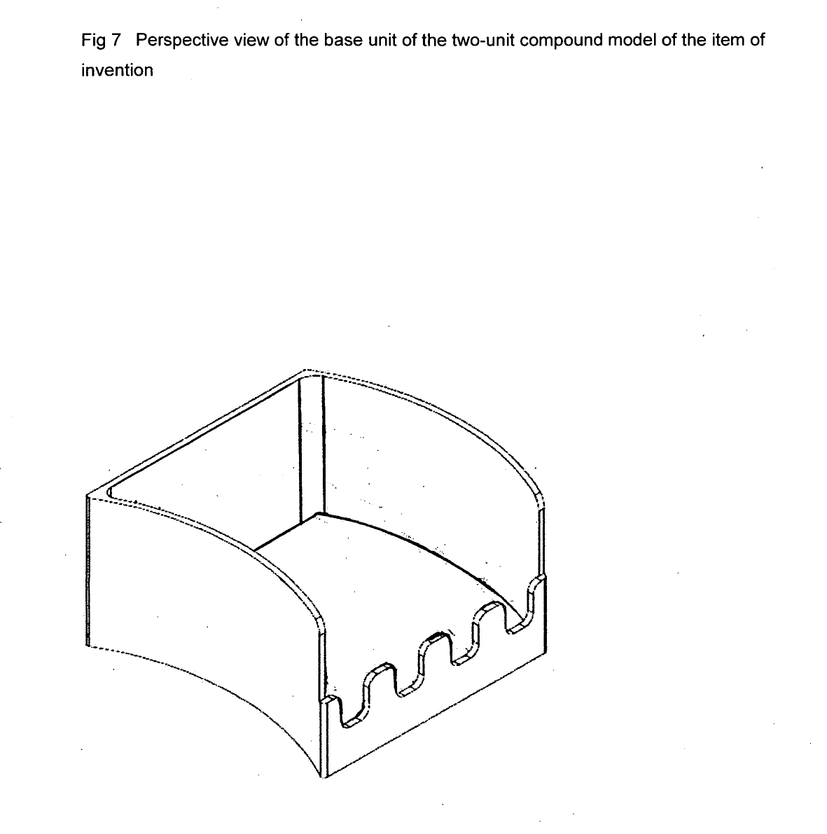

FIG. 7

Perspective view of the base unit of the two-unit compound model of the item of invention

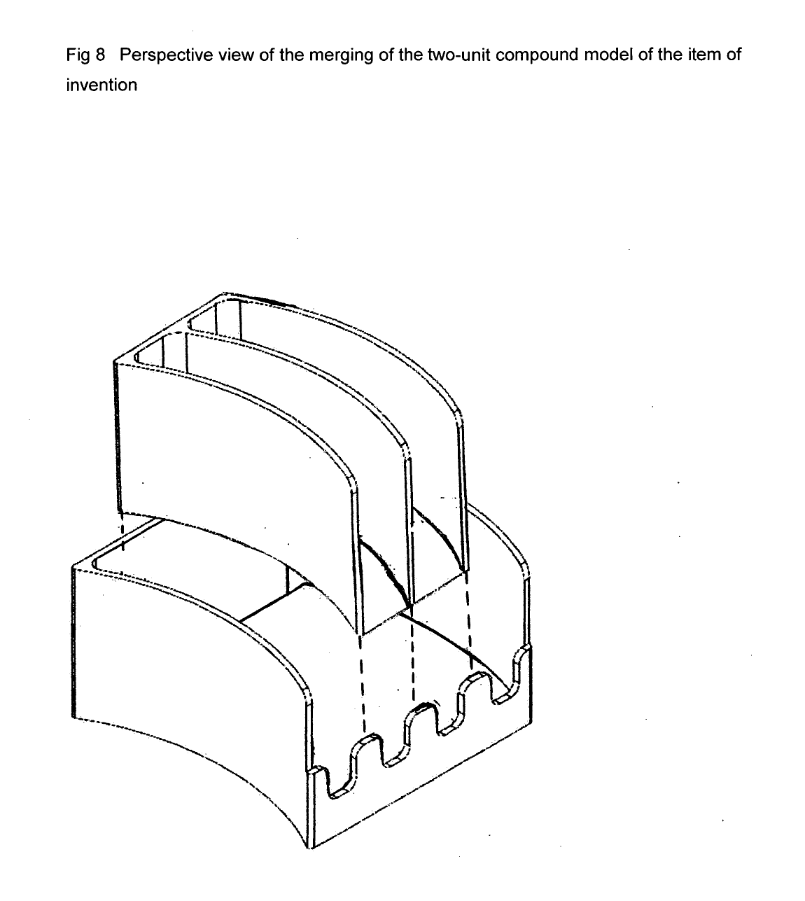

FIG. 8

Perspective view of the merging of the two-unit compound model of the item of invention

### DETAILED DESCRIPTION OF THE INVENTION

The invention is for holding or resting one or more cooking and or serving utensils such that the utensils are rested on their sides in separate compartments of the cooking utensil caddy.

The overall shape of the cooking utensil caddy is as shown in FIG. 1, and may be varied based on decorative, artistic or other preferences. The individual curvature of the compartments may be curved to the right or to the left (for left-handed users).

The main advantage of this cooking utensil caddy is that it compactly and neatly holds one or more cooking utensils with excellent user friendliness.

The single-piece model of the item of invention, as shown in FIG. 1, may be manufactured from plastic or similar material by injection molding, such that liquid plastic is injected into a mold of the item of invention at high temperature and cooled to low temperature to allow the plastic to solidify.

The two-piece model of the item of invention, shown in FIG. 8, may be manufactured from metal alone or metal and glass or other similar material such that the dividing inner piece is manufactured from metal, glass or similar material. The two pieces of the two-piece model may also be glued together to become a one piece model. The curvature of the item of invention may be to the right for right handed user or to the left (for the left handed user).

The lowering of the rear wall of the holding compartment will allow that compartment to hold pot lid with much larger circumference.

The u shaped cutout neck on the lowered front wall of the item of invention allows the utensils to rest in place on the item of invention.

### Uses

Usage of the item of invention for holding or resting cooking spoon is achieved by turning the spoon on its side such that the concave surface or general curvature of the spoon is aligned with the curvature of the target compartment of the item of invention as the spoon is rested in the target compartment.

Usage of the item of invention for resting pot lid is achieved by turning the pot lid on its side such that the curvature of the pot lid is directly aligned with the curvature of the target holding compartment of the item of invention. The pot lid is then placed in the target holding compartment.

1. A cooking utensil caddy, comprising:
(a) A container having multiple curved horizontal compartments for holding cooking utensils and lids
(b) Lowered section of top of front walls of said compartments having u-shaped cutout for resting neck of cooking utensil and outer ring of pot lid
